(19) United States
(12) Patent Application Publication
(10) Pub. No.: US 2020/0103954 A1
(43) Pub. Date: Apr. 2, 2020

(54) INFORMATION PROCESSING DEVICE, CONTROL METHOD, AND NON-TRANSITORY COMPUTER READABLE MEDIUM

(71) Applicant: FUJI XEROX CO., LTD., Tokyo (JP)

(72) Inventors: Hiroshi NIINA, Kanagawa (JP); Masashi OKANO, Kanagawa (JP)

(73) Assignee: FUJI XEROX CO., LTD., Tokyo (JP)

(21) Appl. No.: 16/386,344

(22) Filed: Apr. 17, 2019

(30) Foreign Application Priority Data
Oct. 1, 2018 (JP) 2018-186899

(51) Int. Cl. G06F 1/3228; G06F 1/3287; G06F 1/324

(52) U.S. Cl. CPC G06F 1/3228; G06F 1/324; G06F 1/3287

(57) ABSTRACT

An information processing device includes: an information acquisition unit that acquires information about a power consumption associated with an execution of a program; a determination unit that determines, on a basis of a power-supplying performance of a power supply device and the power consumption information acquired by the information acquisition unit, whether or not the power consumption during the execution of the program according to current operating settings of the information processing device itself exceeds the power-supplying performance of the power supply device; and a setting unit that, in a case in which the determination unit determines that the power-supplying performance of the power supply device is exceeded, adjusts operating settings of a central processing unit (CPU) during the execution of the program such that the power consumption during the execution of the program comes within a range of the power-supplying performance of the power supply device.

### CROSS-REFERENCE TO RELATED APPLICATIONS

This application is based on and claims priority under 35 USC 119 from Japanese Patent Application No. 2018-186899 filed Oct. 1, 2018.

### BACKGROUND

### (i) Technical Field

The present disclosure relates to an information processing device, a control method, and a non-transitory computer readable medium.

### (ii) Related Art

It is possible to add new functions to an information processing device after the fact by adding or changing application software. Japanese Unexamined Patent Application Publication No. 2005-205803 below discloses a controller providing appropriate resources in correspondence with a variety of plotter devices by comparing a parameter expressing the characteristics of a plotter device to a parameter expressing the characteristics of a plotter device that includes the controller, and switching the functions and control of the plotter device.

### SUMMARY

When the functions are changed in an information processing device, a change in the power consumption is anticipated. There are a variety of functions added after the fact, and power supply control capable of flexibly supporting a variety of changes, not limited to only anticipated changes of peripheral equipment, is desired.

Aspects of non-limiting embodiments of the present disclosure relate to power supply controller capable of supporting the changing of functions and the addition of new functions for information processing compared to a configuration that handles changes in power consumption by setting a power consumption margin.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device including: an information acquisition unit that acquires information about a power consumption associated with an execution of a program; a determination unit that determines, on a basis of a power-supplying performance of a power supply device and the power consumption information acquired by the information acquisition unit, whether or not the power consumption during the execution of the program according to current operating settings of the information processing device itself exceeds the power-supplying performance of the power supply device; and a setting unit that, in a case in which the determination unit determines that the power-supplying performance of the power supply device is exceeded, adjusts operating settings of a central processing unit (CPU) during the execution of the program such that the power consumption during the execution of the program comes within a range of the power-supplying performance of the power supply device.

### BRIEF DESCRIPTION OF THE DRAWINGS

An exemplary embodiment of the present disclosure will be described in detail based on the following figures, wherein.

FIG. 1 is a diagram illustrating a configuration of an image processing device to which the exemplary embodiment is applied;

FIG. 2 is a diagram illustrating a configuration of a control device;

FIG. 3 is a diagram illustrating a functional configuration of a control device;

FIG. 4 is a flowchart illustrating bootup operations of the control device;

FIG. 5 is a diagram illustrating the concept of an operation of inserting an idle state between threads;

FIGS. 6A and 6B are diagrams illustrating changes in current during the execution of a process due to the insertion of idle periods, in which FIG. 6A is a diagram illustrating the current for the case in which idle periods are not inserted, and FIG. 6B is a diagram illustrating the current for the case in which idle periods are inserted; and

FIG. 7 is a diagram illustrating control of power consumption according to the setting by the control device.

### DETAILED DESCRIPTION

Hereinafter, an exemplary embodiment of the present disclosure will be described in detail and with reference to the attached drawings. The exemplary embodiment may be applied to information processing devices of various configurations, but herein, the case of application to an image processing device will be described as an example. The image processing device according to the exemplary embodiment is a device for inputting and outputting images, and also for processing and communicating digitized images (that is, images converted into data). Also, the image processing device collects data acquired in the device itself or an external device, and transmits the collected data to a management server. The image processing device may be expanded and given additional functions by adding plugins (programs), peripheral equipment, and the like.

### <Configuration of Information Processing Device>

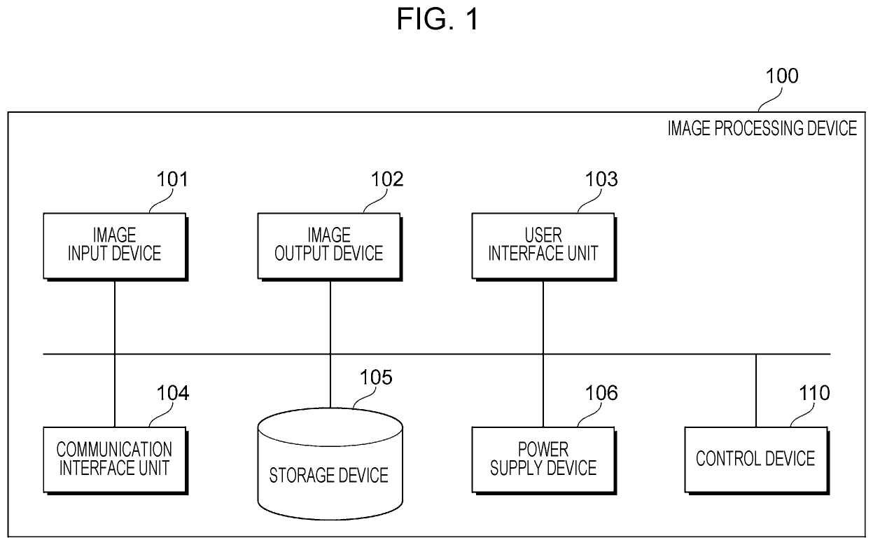

FIG. 1 is a diagram illustrating a configuration of an image processing device to which the exemplary embodiment is applied. The image processing device 100 is one example of an information processing device according to the exemplary embodiment. The image processing device 100 is provided with an image input device 101, an image output device 102, a user interface unit 103, a communication interface unit 104, a storage device 105, a power supply device 106, and a control device 110. The image input device 101, the image output device 102, the user interface unit 103, the communication interface unit 104, and the storage device 105 are examples of peripheral equipment with respect to the control device 110.

The image input device 101 is an image input terminal (IIT). The image input device 101 includes what is commonly called a scanner, and optically reads an image on a set document to generate a scanned image (image data). For the image reading method, for example, a charge-coupled device (CCD) method in which light from a light source is radiated onto a document and the reflected light therefrom is focused by a lens and sensed by a CCD, or a contact image sensor (CIS) method in which light from light-emitting diode (LED) light sources is successively radiated onto a document and the reflected light therefrom is sensed by a CIS is used.

The image output device 102 is an image output terminal (IOT). The image output device 102 includes what is commonly called a printer, and uses image-forming material to form an image based on image data onto a sheet of paper, which is one example of a recording material. For the method of forming an image onto a recording material, for example, an electrophotographic method in which an image is formed by causing toner adhering to a photoconductor to be transferred to a recording material, an inkjet method in which an image is formed by propelling ink onto a recording material, or the like is used.

The user interface (UI) unit 103 is provided with a display section that displays images such as operation screens and information presentation screens, and an input section with which an operator performs input operations. By performing input operations with the input section in accordance with an operation screen displayed on the display section, various control commands and control data are input. For the display section, a liquid crystal display is used, for example. For the input section, hardware keys and a touch sensor are used, for example. As one example, a touch panel combining a liquid crystal display acting as the display section and a touch sensor acting as the input section may be used.

The communication interface unit 104 is a connecting section for connecting to external equipment and exchanging data over a network. Although no particular distinction is made, depending on the type of communication, an Ethernet (registered trademark) network port, a Universal Serial Bus (USB), a wireless communication device for establishing a wireless LAN connection or a Bluetooth (registered trademark) connection, and the like are provided.

The storage device 105 is a device that holds image data used by the image input device 101 and the image output device 102, and holds data acquired in association the operations of the device itself, such as a job log, in association with the exchange of data with external devices, and the like. The storage device 105 is configured using a magnetic disk device and non-volatile memory.

The power supply device 106 is a device that supplies power to each unit of the image processing device 100. The power supply device 106 has a specific power capacity to supply power to each unit. In other words, the power capacity is a characteristic value of the power supply device 106.

The control device 110 is a controller that controls each functional unit of the image processing device 100. The image processing device 100 has a basic function of controlling the devices provided by default, such as the image input device 101, the image output device 102, the user interface unit 103, the communication interface unit 104, and the storage device 105, but additionally controls a variety of operations according to the addition of programs and peripheral equipment.

### <Configuration of Control Device>

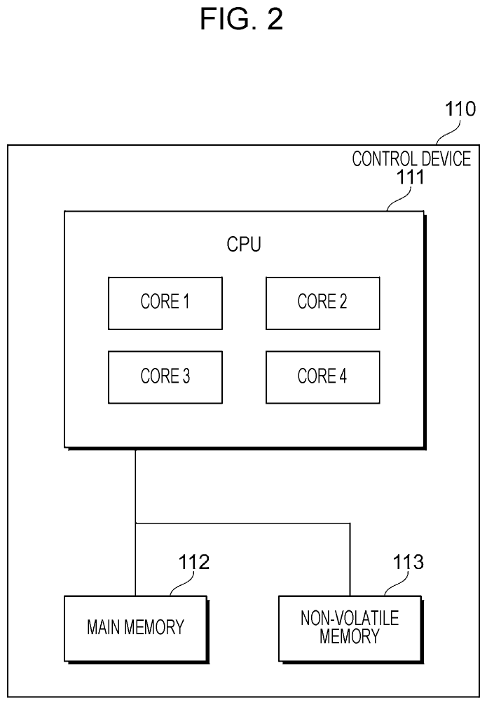

FIG. 2 is a diagram illustrating a configuration of the control device 110. The control device 110 is provided with a central processing unit (CPU) 111 that acts as a computational device, main memory 112, and non-volatile memory 113. In the example illustrated in FIG. 2, the CPU 111 is provided with four processor cores (Core 1 to Core 4). The main memory 112 is used as a work area for processes by the CPU 111. The non-volatile memory 113 stores programs that the CPU 111 loads and executes.

In addition, the non-volatile memory 113 holds a set value of a power consumption margin. The set value of the power consumption margin is an upper limit on the power consumption set so that the image processing device 100 operates stably. In other words, the power consumption margin indicates the power-supplying performance of the power supply device 106. The power consumption margin becomes a different value according to the operating state of the image processing device 100 (such as what process is being performed by which application program). For this reason, the non-volatile memory 113 holds a power consumption margin for each state of the image processing device 100. Also, the non-volatile memory 113 holds a power consumption profile for each application program executed by the CPU 111. A power consumption profile for an application program is information about the power consumed in the execution of the application program by the CPU 111.

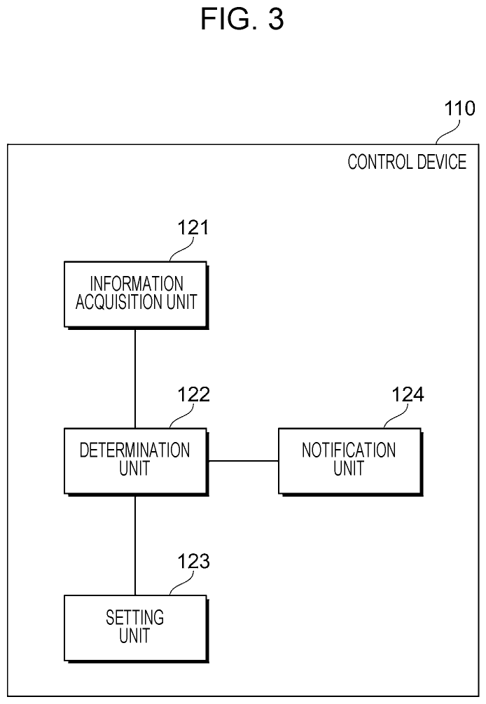

FIG. 3 is a diagram illustrating a functional configuration of the control device 110. The control device 110 is provided with an information acquisition unit 121, a determination unit 122, a setting unit 123, and a notification unit 124. In the control device 110, each of these functions is realized by the CPU 111 illustrated in FIG. 2 executing a program stored in the non-volatile memory 113. Note that, although not particularly illustrated, the control device 110 includes a function of executing application programs for controlling peripheral equipment and performing image processing.

The information acquisition unit 121 acquires the set value of the power consumption margin as well as the power consumption profile for each application program from the non-volatile memory 113. The information acquisition unit 121 acquires this information during the bootup of the image processing device 100.

The determination unit 122 uses the information acquired by the information acquisition unit 121 to determine whether or not the power consumption during the execution of an application program with the current operating settings of the image processing device 100 exceeds the power consumption margin. The determination unit 122 determines whether or not the power consumption in each operating state of the image processing device 100 exceeds the power consumption margin according to each state, such as during standby, when the image input device 101 is operating, and when the image output device 102 is operating.

In the case in which the determination unit 122 determines that the power consumption during the execution of an application program exceeds the power consumption margin, the setting unit 123 configures the operating settings (changes the settings) of the CPU 111 to lower the power consumption during the execution of the application program and bring the power consumption within the range of the power consumption margin. Several methods may be adopted as the specific method of changing the operating settings of the CPU 111. Several techniques that may be used to lower the power consumption during the execution of an application program will be described.

As one example, the setting unit 123 inserts idle periods in which no process is executed between the threads of the application program executed by the CPU 111. By inserting idle periods that do not consume power between threads, the power consumption associated with the execution of each thread does not change, but the overall amount of power consumed when executing several threads associated with a specific process is lowered. By controlling the length of the idle periods and the interval at which to insert the idle periods (the number of threads with respect to which a single idle period is inserted), the amount by which the power consumption is lowered may be controlled. Consequently, the setting unit 123 decides the number of idle periods to insert per unit time according to the adequate amount by which to lower the power consumption to bring the power consumption during the execution of the application program within the range of the power consumption margin, and inserts the idle periods between threads according to the time it takes to execute each thread.

As another example, the setting unit 123 lowers the clock frequency of the CPU 111. For the CPU 111, the lower the clock frequency, the less power is consumed. Accordingly, the setting unit 123 sets the clock rate within the settable range of the CPU 111 according to the adequate amount by which to lower the power consumption to bring the power consumption during the execution of the application program within the range of the power consumption margin.

As another example, in the case in which the CPU 111 has multiple processor cores, the setting unit 123 limits the number of processor cores executing threads of the application program. For a multi-core CPU 111, the fewer the active processor cores, the less power is consumed. Accordingly, the setting unit 123 reduces the number of processor cores made to execute a process (assigned a thread) according to the adequate amount by which to lower the power consumption to bring the power consumption during the execution of the application program within the range of the power consumption margin.

In the case in which the result of the determination by the determination unit 122 is that the lowering of the power that is achievable with the operating settings of the CPU 111 is insufficient to bring the power consumption during the execution of the application program within the range of the power consumption margin, the notification unit 124 issues a notification of this state. Also, the notification unit 124 issues a notification of information indicating the power-supplying performance of the power supply device 106 that would be sufficient to bring the power consumption during the execution of the application program within the range of the power consumption range. Also, the notification unit 124 issues a notification prompting the user to replace the power source device 106. Note that besides the power source device 106, notification may also be issued to prompt the user to replace a part that operate during the execution of the application program, such as the panel of the display section of the UI unit 103, with a part that consumes less power. These notifications may be issued by displaying messages on the display section of the UI unit 103, for example.

### <Operations of Control Device>

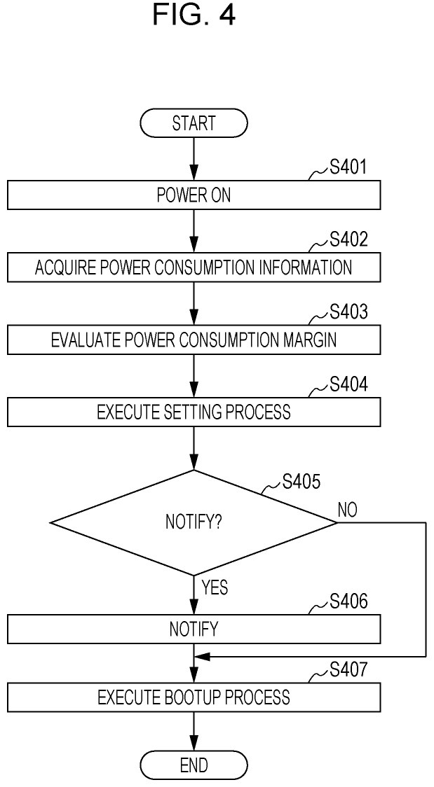

FIG. 4 is a flowchart illustrating bootup operations of the control device 110. When the image processing device 100 is powered on (S401), the information acquisition unit 121 of the control device 110 acquires power consumption information from the non-volatile memory 113 (S402). Herein, the power consumption information refers to the set value of the power consumption margin as well as the power consumption profile for each application program.

Next, the determination unit 122 uses the information acquired in S402 evaluates the power consumption margin (S403). Specifically, the determination unit 122 determines whether or not the power consumption in each state exceeds the power consumption margin, according to the operating state of the image processing device 100. Also, in the case in which the power consumption exceeds the power consumption margin, the determination unit 122 determines the adequate amount by which to lower the power consumption and the settings of the CPU 111 for achieving such a lowering of the power consumption. Also, the determination unit 122 determines whether or not an adequate lowering of the power consumption is achievable with the settings of the CPU 111 (whether or not to notify the user).

The settings determined by the determination unit 122 are the techniques that may be employed to lower the power consumption and the degree to which to apply the techniques. For example, in the case in which the techniques that may be employed, are inserting idle periods between threads (technique 1), lowering the clock frequency of the CPU 111 (technique 2), and limiting the number of processor cores executing processes (technique 3), the determination unit 122 selects which technique to use. A technique may also be selected, in accordance with a predetermined priority, for example. As one example, because technique 1 is able to set the amount by which to lower the power consumption for each application program and also finely control the amount by which to lower the power consumption, technique 1 may be applied with priority, while techniques 2 and 3 that have stepped control of the power consumption may be applied in a supplementary manner. Also, the user may be queried regarding which technique to apply, and a selection operation by the user may be received to specify the technique to apply. The issuing of a query to the user and the reception of a selection operation may be performed by displaying a query message and an operation screen on the display section of the UI unit 103, for example.

Additionally, the determination unit 122 specifies the degree to which to apply the selected technique. For example, in the case of selecting technique 1, the number of idle periods to insert per unit time is specified. Also, in the case of selecting technique 2, the clock frequency is specified, Also, in the case of selecting technique 3, the number of processor cores to run is specified. The user may also be queried regarding these degrees of application, and a selection operation by the user may be received to specify the degree of application. Similarly to selecting a technique, the query regarding the degree of application may be performed by displaying a query message and an operation screen on the display section of the UI unit 103.

Next, the setting unit 123 adjusts the CPU 111 in accordance with the settings determined by the determination unit 122 (S404). Note that in the determination of S403, in the case in which the determination unit 122 determines that the power consumption does not exceed the power consumption margin, the setting unit 123 maintains the current settings.

Next, in the case in which the determination unit 122 determines that an adequate lowering of the power consumption is not achievable with the settings of the CPU 111 (that is, determines to notify the user) (S405, YES), the notification unit 124 issues an appropriate notification to the user (S406). Subsequently, the process of booting up the image processing device 100 is continued (S407). On the other hand, in the case in which the determination unit 122 determines not to notify the user (S405, NO), the process of booting up the image processing device 100 continues without a notification by the notification unit 124 (S407).

### <Control of Power Consumption by Inserting Idle Periods>

The relationship between the setting by the control device 110 and the lowering of power consumption will be described further. The techniques for lowering the power consumption described above may also be used in combination. Hereinafter, the case of combining technique 1 and technique 2 described above will be described.

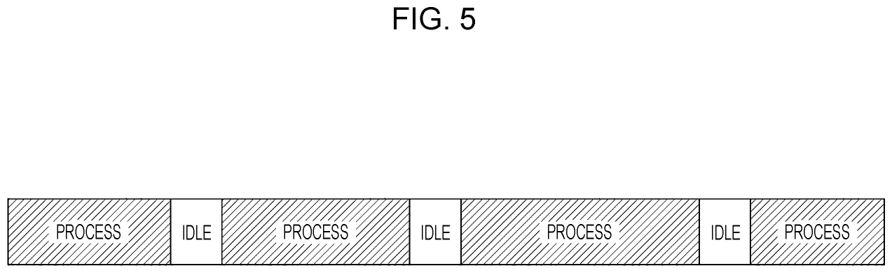

FIG. 5 is a diagram illustrating the concept of the operation of inserting an idle state between threads. In FIG. 5, the periods labeled “Process” are times in which a process is being executed by an application program. The periods labeled “Idle” are idle periods in which no process is being executed. In the “Process” periods, the processes of one or multiple threads are executed. The control device 110 executes an application program in units of threads. On the other hand, on the basis of the power consumption margin and the power consumption during the execution of an application program, the setting unit 123 of the control device 110 decides an adequate amount by which to lower the power consumption, and sets the length and insertion intervals of the idle periods. Since the idle periods are inserted between threads, the insertion intervals become intervals of one or multiple threads. However, the insertion intervals do not necessarily have to be equal intervals, and different intervals may also be set according to the process to be executed.

Herein, the case of image processing (such as image alteration and data format conversion) will be taken as an example to further describe the insertion of idle periods. The setting unit 123 partitions an entire image to be processed into multiple sub-regions shaped like tiles, and processes the sub-regions individually. A single sub-region is the size with which a process is executed by one or multiple threads. The size of the sub-regions (the granularity of partitioning) changes depending on the type of process, and the sizes of all sub-regions do not necessarily have to be the same size. For example, the execution time for the case of executing the process on an A4-sized image may be measured in advance, and the number of partitions to use in the case of executing the process on an A4-sized image may be computed. Additionally, the setting unit 123 sets idle periods to be inserted between the processes performed on the one or multiple sub-regions.

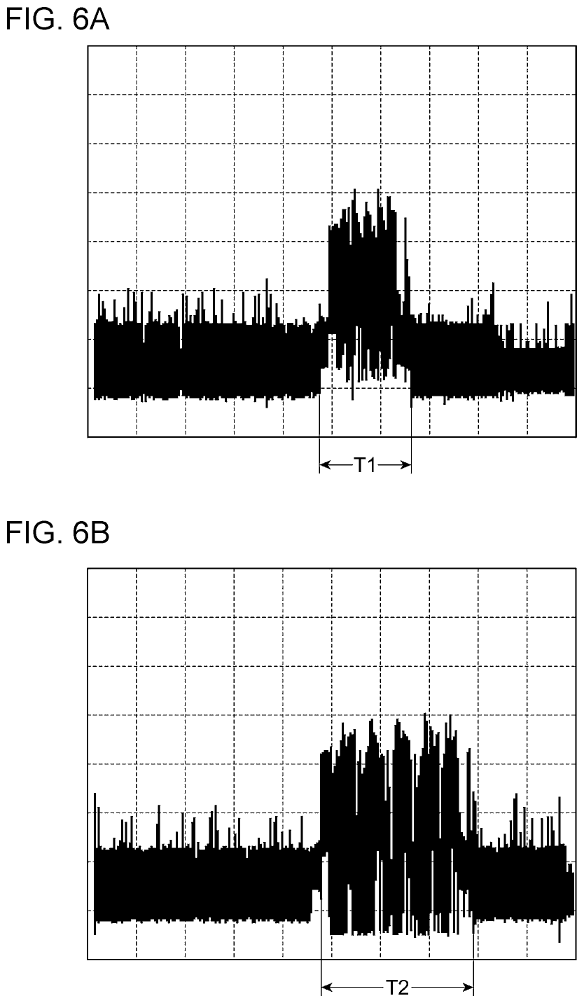

FIGS. 6A and 6B are diagrams illustrating changes in current during the execution of a process due to the insertion of idle periods. FIG. 6A is a diagram illustrating the current for the case in which idle periods are not inserted, and FIG. 6B is a diagram illustrating the current for the case in which idle periods are inserted. The time T1 in FIG. 6a and the time T2 in FIG. 6B are the times during which a process is being executed by an application program. A comparison of the time T1 and the time T2 demonstrates that the time T2 is longer due to the insertion of idle periods. In other words, the process takes more time. However, the minimum value of the current during the execution of the process is smaller for the current illustrated in FIG. 6B. With this arrangement, the power consumption during the execution of the process may be lowered and kept within the range of the power consumption margin.

### <Example of Control of Power Consumption>

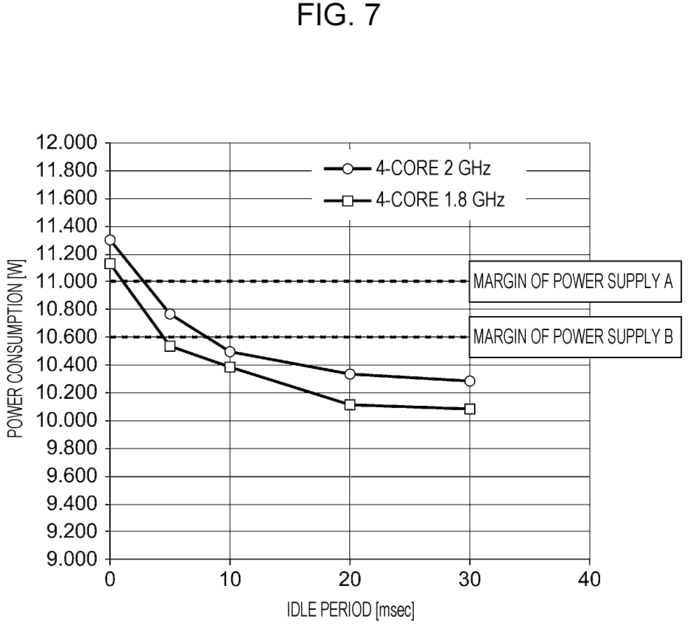

FIG. 7 is a diagram illustrating the control of power consumption according to the setting by the control device 110. In the example illustrated in FIG. 7, the power consumption margin in the case of using a power supply A as the power supply device 106 is 11.000 W, while the power consumption margin in the case of using a power supply B is 10.600 W. The CPU 111 has four processor cores, which may operate at a clock rate of 2 GHz or 1.8 GHz.

Consider the case in which the power supply device 106 is the power supply A and the CPU 111 operates at a clock rate of 2 GHz. Referring to FIG. 7, the power consumption when the image processing device 100 is in a certain operating state is 11.300 W, exceeding the power consumption margin of 11.000 W. Accordingly, if a 5 millisecond (msec) idle period is inserted, the power consumption becomes 10.800 W or less, falling below the power consumption margin.

Also consider the case in which the power supply device 106 is the power supply B and the CPU 111 operates at a clock rate of 2 GHz. In this case, referring to FIG. 7 even if a 5 msec idle period is inserted, the power consumption margin still exceeds 10.600 W. Accordingly, if the idle period is set to 10 msec, the power consumption becomes 10.500 W, falling below the power consumption margin.

At this point, consider the case in which the power supply device 106 is the power supply B, and it is desirable to make the idle period as short as possible. Accordingly, the technique of lowering the CPU clock frequency is used at the same time. Referring to FIG. 7, in the case of setting the CPU clock frequency to 1.8 GHz, the power consumption when an idle period is not inserted exceeds the power consumption margin of 10.600 W for the power supply B. However, if a 5 millisecond (msec) idle period is inserted, the power consumption becomes 10.600 W or less, falling below the power consumption margin. In other words, by using the technique of lowering the CPU clock frequency at the same time, a power consumption that falls below the power consumption margin is achieved while also moderating the length of the idle period to insert. In this way, by using multiple techniques together, the target power consumption may be obtained while moderating the degree of application of one technique.

The foregoing thus describes an exemplary embodiment of the present disclosure, but the technical scope of the present disclosure is not limited to the foregoing exemplary embodiment. For example, although the foregoing exemplary embodiment describes an example of applying the exemplary embodiment to the image processing device 100 acting as one example of an information processing device, the power consumption may be controlled in various other types of information processing devices by techniques such as inserting idle periods, lowering the clock frequency, and reducing the number of processor cores used by a process. Otherwise, various modifications and substitutions that do not depart from the scope of the technical ideas of the present disclosure are also included in the present disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
an information acquisition unit that acquires information about a power consumption associated with an execution of a program;
a determination unit that determines, on a basis of a power-supplying performance of a power supply device and the power consumption information acquired by the information acquisition unit, whether or not the power consumption during the execution of the program according to current operating settings of the information processing device itself exceeds the power-supplying performance of the power supply device; and
a setting unit that, in a case in which the determination unit determines that the power-supplying performance of the power supply device is exceeded, adjusts operating settings of a central processing unit (CPU) during the execution of the program such that the power consumption during the execution of the program comes within a range of the power-supplying performance of the power supply device.

2. The information processing device according to claim 1, wherein
the setting unit lowers the power consumption during the execution of the program by inserting an idle period in which no process is executed between program threads executed by the CPU to execute the program.

3. The information processing device according to claim 2, wherein
the setting unit computes a number of idle periods to insert per a unit time according to an adequate amount by which to lower the power consumption, and inserts the idle periods between the threads according to a time taken to execute each thread.

4. The information processing device according to claim 1, wherein
the setting unit lowers the power consumption during the execution of the program by lowering a clock frequency of the CPU.

5. The information processing device according to claim 1, wherein
the CPU has multiple processor cores, and
the setting unit lowers the power consumption during the execution of the program by limiting the processor cores that execute program threads that realize the program.

6. The information processing device according to claim 1, further comprising:
a notification unit that, in a case in which the determination unit determines that a maximum amount of lowering the power consumption during the execution of the program that is achievable with the operating settings of the CPU is smaller than the adequate amount by which to lower the power consumption to within the range of the power-supplying performance of the power supply device, issues a notification indicating that an adequate lowering of the power consumption is not achievable with the operating settings of the CPU.

7. The information processing device according to claim 6, wherein
the notification unit issues, in addition to the notification, a notification of information indicating an adequate power-supplying performance and also prompting a user to replace the power supply device.

8. A control method of an information processing device, the control method comprising:
acquiring information about a power consumption associated with an execution of a program;
determining, on a basis of a power-supplying performance of a power supply device and the power consumption information, whether or not the power consumption during the execution of the program according to current operating settings of the information processing device itself exceeds the power-supplying performance of the power supply device; and
in a case of determining that the power-supplying performance of the power supply device is exceeded, adjusting operating settings of a central processing unit (CPU) during the execution of the program such that the power consumption during the execution of the program comes within a range of the power-supplying performance of the power supply device.

9. A non-transitory computer readable medium storing a program causing a computer to execute a process for processing information, the process comprising:
acquiring information about a power consumption associated with an execution of an application program;
determining, on a basis of a power-supplying performance of a power supply device and the power consumption information, whether or not the power consumption during the execution of the application program according to current operating settings of the information processing device itself exceeds the power-supplying performance of the power supply device; and
in a case of determining that the power-supplying performance of the power supply device is exceeded, adjusting operating settings of a central processing unit (CPU) during the execution of the application program such that the power consumption during the execution of the application program comes within a range of the power-supplying performance of the power supply device
